(19) United States
(12) Patent Application Publication
(10) Pub. No.: US 2015/0235766 A1
(43) Pub. Date: Aug. 20, 2015

(54) Stacked Film Capacitor and Manufacturing Method of Stacked Film Capacitor

(71) Applicant: Murata Manufacturing Co., Ltd., Nagaokakyo-shi (JP)

(72) Inventor: Shigeki Nishiyama, Nagaokakyo-shi (JP)

(21) Appl. No.: 14/626,152

(22) Filed: Feb. 19, 2015

(30) Foreign Application Priority Data
Feb. 20, 2014 (JP) 2014-031107

(51) Int. Cl. H01G 4/012; H01G 13/00; H01G 4/30; H01G 4/228

(52) U.S. Cl. CPC H01G 4/012; H01G 4/228; H01G 13/00; H01G 4/30

(57) ABSTRACT

A method of manufacturing a stacked film capacitor that includes forming a plurality of first and second internal electrodes on first and second dielectric films, forming first and second separation lines between the plurality of first and second internal electrodes on the first and second dielectric films, stacking the first and second dielectric films in such a way that the first and second separation lines are arranged at positions different from each other when seen along a stacking direction to form a stack, separating the stack at the first and second separation lines into a plurality of separated stacks by applying forces in opposite directions to each other to the first and second dielectric films across the first and second separation lines, and forming first and second external electrodes connected to the first and second internal electrodes, respectively.

### BACKGROUND OF THE INVENTION

1. Field of the Invention

The present invention relates to a stacked film capacitor, and a manufacturing method of the stacked film capacitor.

2. Description of the Related Art

Techniques for manufacturing one of stacked and wound film capacitors for securing electrical connection between an internal electrode and a Metallikon section (an external electrode) deposited on a film of a film capacitor are disclosed, for example, in JP 2006-294789 A, JP 8-102427 A, and JP 1-248607 A (hereinafter referred to as Patent Documents 1 to 3).

Patent Document 1 discloses a method of manufacturing a stacked film capacitor by stacking a plurality of films on which internal electrodes are deposited while alternately shifting the films by a specific amount, and by causing the internal electrode exposed on each layer to be in contact with a Metallikon section.

Patent Document 2 discloses a method of manufacturing a wound film capacitor by stacking metallized films, causing an internal electrode to be exposed by contracting the film by heat treatment, and causing the exposed portion of the internal electrode and a Metallikon section to be in contact with each other.

Patent Document 3 discloses a method of manufacturing one of stacked and wound film capacitors by stacking metallized films, causing an internal electrode to be exposed by injecting gas including a component that reacts only with the film, and causing the exposed portion of the internal electrode and a Metallikon section to be in contact with each other.

### SUMMARY OF THE INVENTION

The methods disclosed in Patent Documents 1 to 3 are disadvantageous in that the manufacturing efficiency is low. With the method disclosed in Patent Document 1, it is not possible to manufacture a plurality of film capacitors from a film on which internal electrodes are arrayed in a matrix. This method at least needs to use a rectangular sheet on which internal electrodes are arrayed in one row. Thus, the efficiency is not very high. Also, the method disclosed in Patent Document 2 needs heat treatment at a high temperature to cause the film to contract. The method disclosed in Patent Document 3 needs a step of injecting gas.

The present invention has been made in view of the above circumstances, and has its aim to provide a stacked film capacitor that can be manufactured with high manufacturing efficiency, and a manufacturing method of the stacked film capacitor.

A manufacturing method of a stacked film capacitor according to a first aspect of the present invention is a manufacturing method of a stacked film capacitor where a first internal electrode, a first dielectric film, a second internal electrode, and a second dielectric film are stacked in this order, and where the first internal electrode and the second internal electrode face each other across the first dielectric film, the stacked film capacitor including a first external electrode connected to the first internal electrode and a second external electrode connected to the second internal electrode, the manufacturing method including:

an internal electrode forming step of forming a plurality of first internal electrodes on the first dielectric film, and of forming a plurality of second internal electrodes on the second dielectric film;

a separation line forming step of forming a first separation line at a position between the plurality of first internal electrodes on the first dielectric film, and of forming a second separation line at a position between the plurality of second internal electrodes on the second dielectric film;

a stacking step of stacking the first dielectric film where the first separation line is formed and the second dielectric film where the second separation line is formed in such a way that the first separation line and the second separation line are arranged at positions different from each other when seen along a stacking direction, and of forming a stack;

a separation step of separating the stack at the first separation line and the second separation line into a plurality of separated stacks by applying forces in opposite directions to each other to the first dielectric film and the second dielectric film positioned on one side of the first separation line and the second separation line and to the first dielectric film and the second dielectric film positioned on another side, respectively; and

an external electrode forming step of forming a first external electrode to be connected to the first internal electrode and a second external electrode to be connected to the second internal electrode.

In the external electrode forming step, the first external electrode and the second external electrode may be formed by Metallikon treatment.

In the separation line forming step, the first separation line may be formed at a position adjacent to the first internal electrode on the first dielectric film, and the second separation line may be formed at a position adjacent to the second internal electrode on the second dielectric film,

in the stacking step, the first dielectric film and the second dielectric film may be stacked in such a way that the first internal electrode is exposed at one end surface of the separated stack, and the second internal electrode is exposed at another end surface of the separated stack, and

in the external electrode forming step, the first external electrode may be formed on the one end surface of the separated stack and the second external electrode may be formed on the other end surface of the separated stack.

In the internal electrode forming step, the first internal electrode including an extended area and a main area may be formed on the first dielectric film, and the second internal electrode including an extended area and a main area may be formed on the second dielectric film,

in the separation line forming step, the first separation line may be formed at a position adjacent to the extended area of the first internal electrode on the first dielectric film, and the second separation line may be formed at a position adjacent to the extended area of the second internal electrode on the second dielectric film,

in the stacking step, the first dielectric film and the second dielectric film may be stacked in such a way that the extended area of the first internal electrode is exposed at an end surface of the separated stack, and the extended area of the second internal electrode may be exposed at a position that is, in a plan view of the separated stack, different from the position of the extended area of the first internal electrode, and

in the external electrode forming step, the first external electrode to be connected to the extended area of the first internal electrode and the second external electrode to be connected to the extended area of the second internal electrode may be formed at an end surface of the separated stack.

In the separation line forming step, a third separation line that is orthogonal to the first separation line may be formed on the first dielectric film, and a fourth separation line that is orthogonal to the second separation line may be formed on the second dielectric film, and

in the stacking step, the first dielectric film where the third separation line is formed and the second dielectric film where the fourth separation line is formed may be stacked in such a way that the third separation line and the fourth separation line are arranged at an overlapping position when seen along a stacking direction.

A stacked film capacitor according to a second aspect of the present invention is manufactured by the manufacturing method of a stacked film capacitor according to the first aspect of the present invention.

A stacked film capacitor according to a third aspect of the present invention is a stacked film capacitor where a first internal electrode, a first dielectric film, a second internal electrode, and a second dielectric film are stacked in this order, and where the first internal electrode and the second internal electrode face each other across the first dielectric film, the stacked film capacitor including a first external electrode connected to the first internal electrode and a second external electrode connected to the second internal electrode,

wherein the first dielectric film and the second dielectric film include broken portions at peripheral portions.

According to the present invention, a stacked film capacitor that can be manufactured with high manufacturing efficiency, and a manufacturing method of the stacked film capacitor can be provided.

### BRIEF DESCRIPTION OF THE DRAWINGS

FIG. 1 is a flow chart showing a manufacturing method of a stacked film capacitor according to a first embodiment of the present invention;

FIG. 2 is a plan view showing internal electrode layers formed in an internal electrode layer forming step;

FIG. 3 is a plan view showing the positions of separation lines formed in a separation line forming step;

FIG. 4 is a plan view showing sheets made in a sheet making step;

FIGS. 5A and 5B are plan views showing the orientations of sheets to be stacked in a stacking step;

FIG. 6 is a cross-sectional view showing the positions of sheets stacked in the stacking step;

FIG. 7 is a plan view showing a separation method used in a separation step;

FIG. 8 is a cross-sectional view showing the separation method used in the separation step;

FIGS. 9A, 9C and 9E are views showing the positions and shapes of the separation lines in the separation step, and FIGS. 9B, 9D and 9F are views showing the shapes of sheets after separation;

FIG. 10 is a cross-sectional view showing a stacked film capacitor where Metallikon sections are formed;

FIGS. 11A and 11B are plan views showing internal electrode layers formed in the internal electrode layer forming step;

FIGS. 12A and 12B are plan views showing the positions of separation lines formed in the separation line forming step;

FIGS. 13A and 13B are plan views showing sheets made in the sheet making step;

FIG. 14A is a plan view of a stacked film capacitor where Metallikon sections are formed, and FIG. 14B is a cross-sectional view of FIG. 14A along the line b-b;

FIGS. 15A and 15B are cross-sectional views of a capacitor module; and

FIGS. 16A and 16B are cross-sectional views of another capacitor module.

### DETAILED DESCRIPTION OF THE INVENTION

Hereinafter, embodiments of the present invention will be described in detail with reference to the drawings. Additionally, in the drawings, the same or equivalent portions are denoted by the same reference numerals.

### First Embodiment

A manufacturing method of a stacked film capacitor according to a first embodiment of the present invention will be described with reference to the drawings.

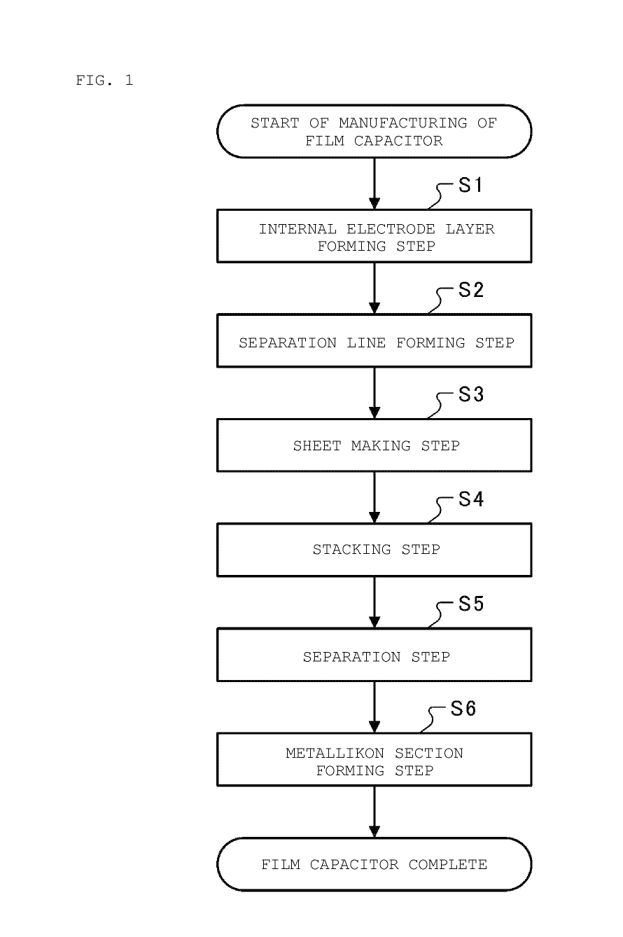

As shown in FIG. 1, the manufacturing steps of the stacked film capacitor roughly includes an internal electrode layer forming step (step S1), a separation line forming step (step S2), a stacking step (step S4), and a separation step (step S5).

(Internal Electrode Layer Forming Step)

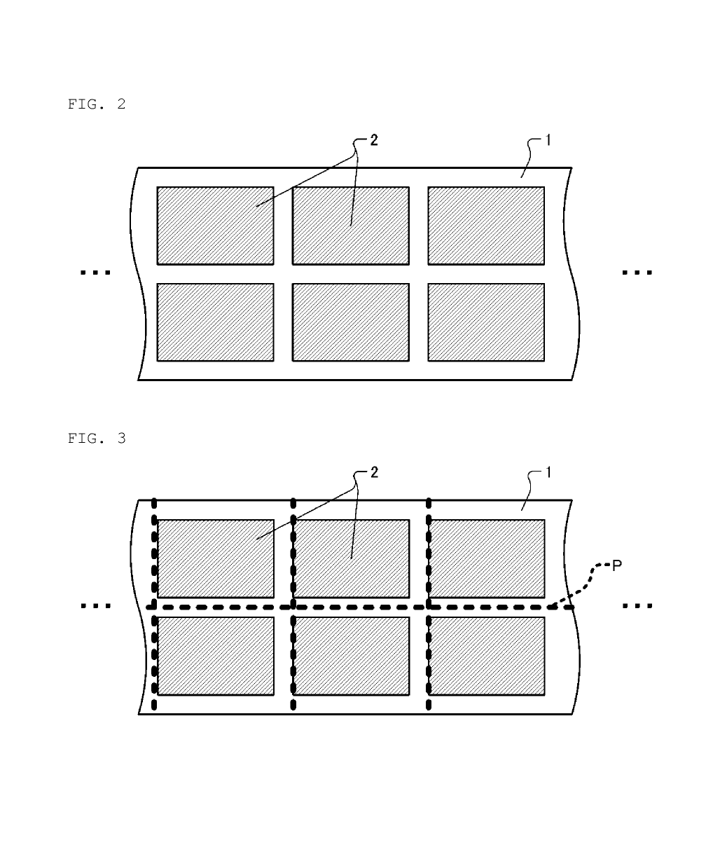

As shown in FIG. 2, in the internal electrode layer forming step (step S1), a plurality of internal electrode layers 2 are formed in row and column directions on the surface of a film 1 made of dielectric material such as plastic or ceramic. The thickness of the film 1 is several micrometers (μm), and the width (the length in the short direction) is several tens of millimeters (mm). The internal electrode layers 2 are formed, for example, by depositing a metal film on the film 1 and by burning the same, and are formed, for example, along the long direction (the row direction) of the film 1 at certain intervals, with two layers arranged in the short direction of the film 1. The internal electrode layer 2 is a layer that functions as the internal electrode of the capacitor.

Furthermore, the internal electrode layer 2 is made of an electrical conductor such as aluminum (Al), copper (Cu), silver (Ag) or the like. The thickness of the internal electrode layer 2 is several nanometers (nm).

(Separation Line Forming Step)

As shown in FIG. 3, in the separation line forming step of step S2, separation lines P (separation lines, cutting lines) are formed along the short and long directions of the film 1 on which a plurality of internal electrode layers 2 are formed. The separation line P along the short direction of the film 1 is formed along one side (an end portion) of the internal electrode layer 2, and the separation line P along the long direction of the film 1 is formed in the middle of the short direction (between the internal electrode layers 2) of the film 1. The separation lines P along the short direction of the film 1 are formed according to the pitch between the internal electrode layers 2 in the long direction.

The mode of the separation line P is arbitrary so long as the film 1 may be easily separated along the separation line P when tension is applied in opposite directions across the separation line P. For example, holes of certain or inconstant length may be formed at certain or random intervals (a so-called perforation). Holes may be provided in the entire middle portion of the film 1 except for both end portions. Alternatively, the film 1 may be cut to a certain depth from the upper surface (or the lower surface), and a part near the lower surface (or the upper surface) may be preserved. Furthermore, these may be combined.

The separation line P may be formed by a cutter, for example. The cutter may be one of a knife and a laser cutter.

(Sheet Making Step)

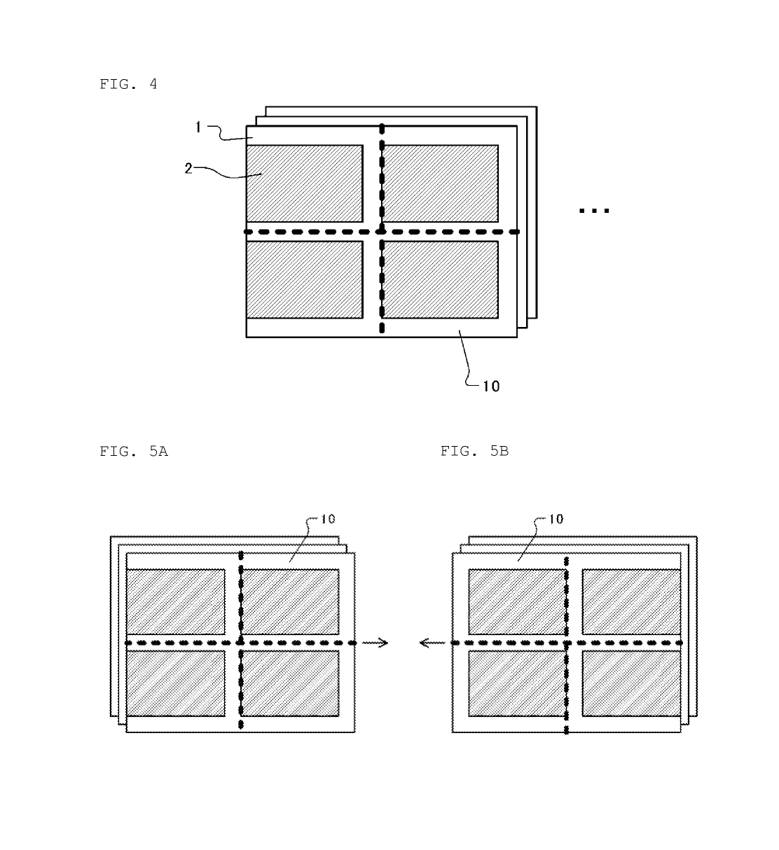

As shown in FIG. 4, in the sheet making step in step S3, every second separation line P formed along the short direction of the film 1 is cut by a cutter or the like (for example, even-numbered or odd-numbered separation lines P are cut). One film 1 is thereby divided into a plurality of sheets 10. Moreover, each sheet 10 includes four internal electrode layers 2.

(Stacking Step)

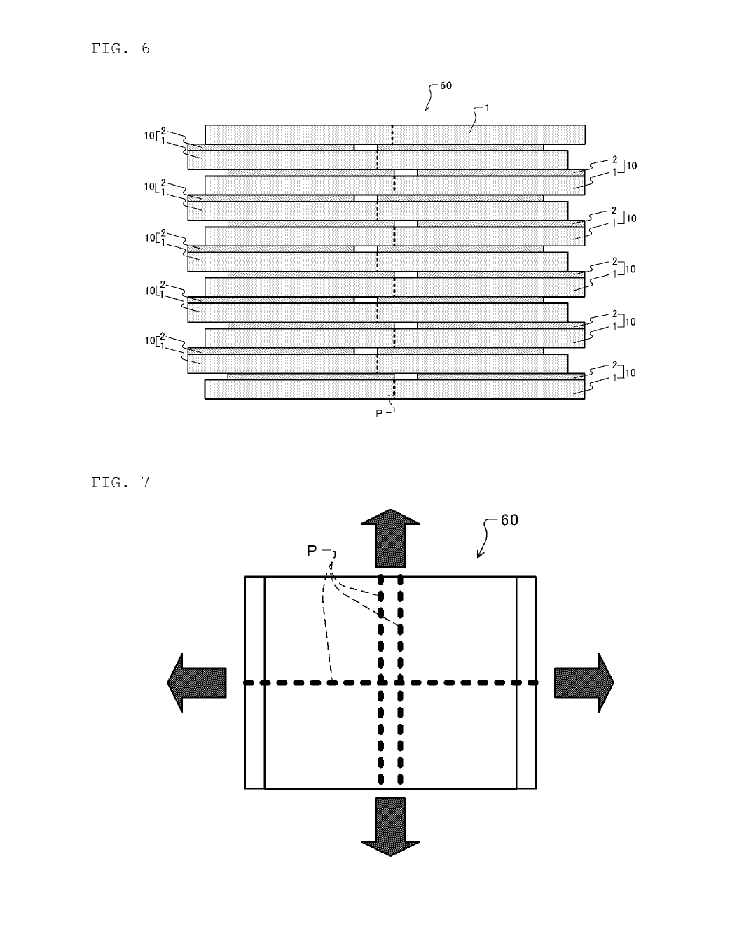

In the stacking step in step S4, the plurality of sheets 10 are divided into two sets. Subsequently, one of the two sets of the sheets 10 is reversed by 180 degrees, and sheets 10 whose internal electrode layers 2 are partially exposed at a left end portion in the drawing, as shown in FIG. 5A, and sheets 10 whose internal electrode layers 2 are partially exposed at a right end portion in the drawing, as shown in FIG. 5B, are prepared. Then, as shown in FIG. 6, the reversed sheets 10 and the non-reversed sheets 10 are alternately stacked. At the time of stacking, a plurality of sheets are positioned and stacked with the positions of the reversed sheets 10 and the non-reversed sheets 10 shifted from each other in such a way that the internal electrode layer 2 is partially exposed at an end portion of each sheet 10 of the stack. The internal electrode layer 2 of the reversed sheet 10 and the internal electrode layer 2 of the non-reversed sheet 10 are arranged facing each other, with their positions shifted from each other. Also, a film 1 having the same size as the film 1 of the sheet 10 is stacked at the uppermost layer for insulation and protection. A stack 60 is thereby formed.

(Separation Step)

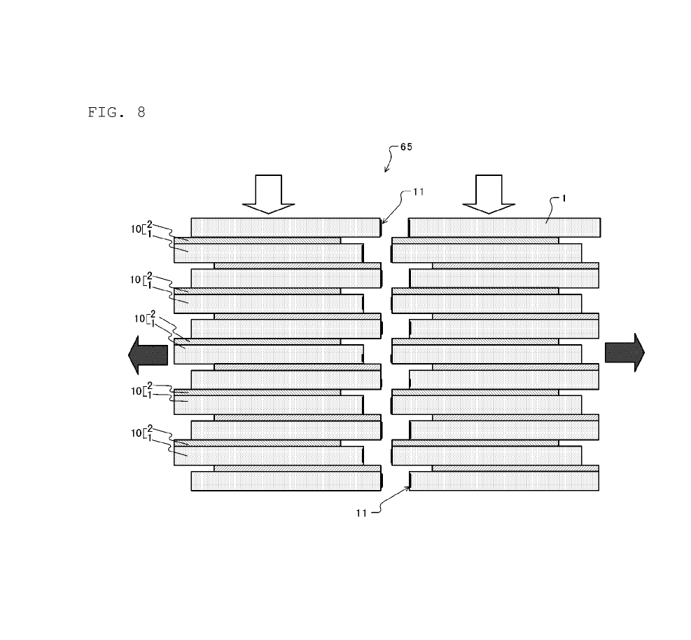

In the separation step in step S5, each sheet 10 of the stack 60 is separated along the separation line P. For example, as shown in FIGS. 7 and 8, the stack 60 is pulled from both sides of the short direction. Tension concentrates at a portion of the separation line P formed along the short direction of each sheet 10 which was not cut and is therefore preserved, and the portion is broken, and thus, each sheet 10 is separated into two. Accordingly, each sheet 10 of the stack 60 changes from a state where four internal electrode layers 2 are provided to a state where two internal electrode layers 2 are provided.

Subsequently, the separated stack 60 is pulled from both sides of the long direction. Then, the separation line P formed along the long direction of each sheet 10 is separated, and each sheet 10 is further separated into two. The stack 60 is thereby separated into separated stacks 65 where each sheet 10 includes one internal electrode layer 2. Additionally, to maintain the stacked state of the sheets 10, the stack 60 may be pulled while being pressed in the stacking direction.

As shown in FIG. 8, due to this separation step, a separated stack 65 having the internal electrode layer 2 of an odd-numbered sheet 10 exposed at one end and the internal electrode layer 2 of an even-numbered sheet 10 exposed at the other end is formed.

A broken portion 11 is formed in the separation step on the separated surface of the separated stack 65. The broken portion 11 is formed from a surface that is not continuous with the separated surface of the separation line formed by breaking. Due to the tension and breaking, the broken portion 11 may include portions called extension, burr, lug, chip, and the like. The shape of the separation line P to be formed in the separation line forming step and the force to be applied in the separation step are selected by experiments, for example, in such a way that the broken portion 11 would not affect the properties of a completed element.

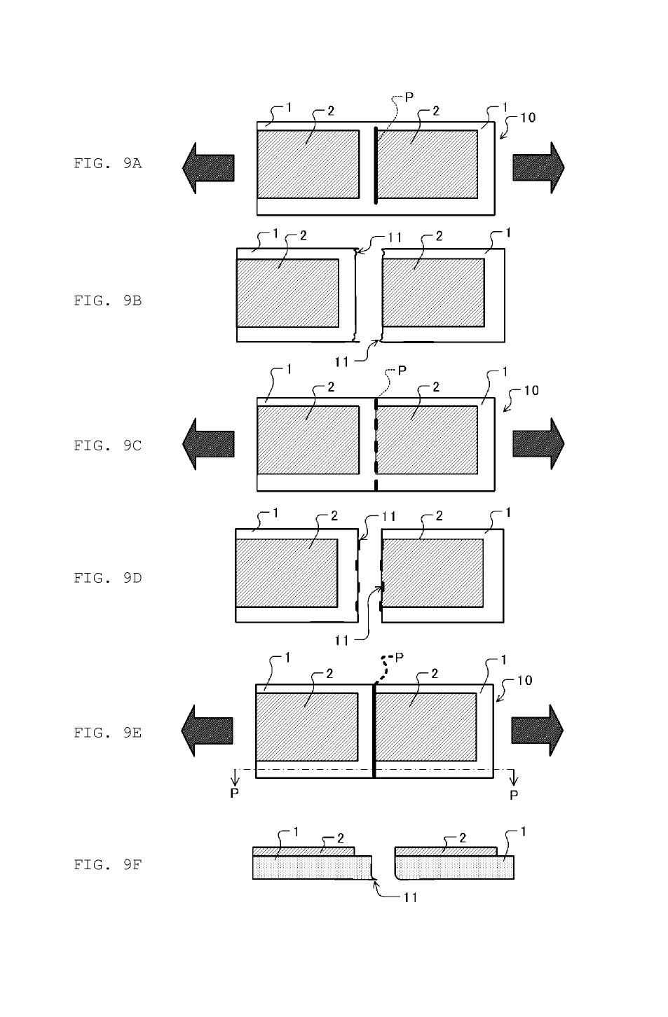

To describe with reference to a concrete example, the separation line P shown in FIG. 9A cuts a part of the sheet 10 other than both end portions. As shown in FIG. 9B, when separating by the separation line P shown in FIG. 9A, the broken portions 11 are formed at both ends of the separated surface of the separation line P. The separation line P shown in FIG. 9C cuts the sheet 10 in a dotted manner. As shown in FIG. 9D, when separating by the separation line P shown in FIG. 9C, the broken portions 11 are formed between the dotted parts which have been cut. Seen along the cross-sectional direction of the sheet 10, the separation line P shown in FIG. 9E cuts from the upper surface side on which the internal electrode layer 2 of the sheet 10 is formed to slightly above the lower surface opposite to the upper surface. As shown in FIG. 9F, when separating by the separation line P shown in FIG. 9E, the broken portion 11 is formed near the surface opposite to the surface where the internal electrode layer 2 of the sheet 10 is formed.

(Metallikon Section Forming Step)

In a Metallikon section forming step in step S6, Metallikon sections (external electrodes) 4 and 5 are formed by thermally spraying a thermal spray material (a metallic material such as nickel, aluminum, etc.) on the surfaces of the separated stack 65 where the internal electrode layers 2 are exposed, that is, both end surfaces of the separated stack 65 shown in FIG. 8. The thermal spray material is thermally sprayed onto the internal electrode layer 2 that is exposed at the separation line at an end portion of each sheet 10. Internal electrodes formed from the internal electrode layers 2 and the Metallikon sections 4 and 5 are thereby made to be in contact with each other, and electrical connection is secured.

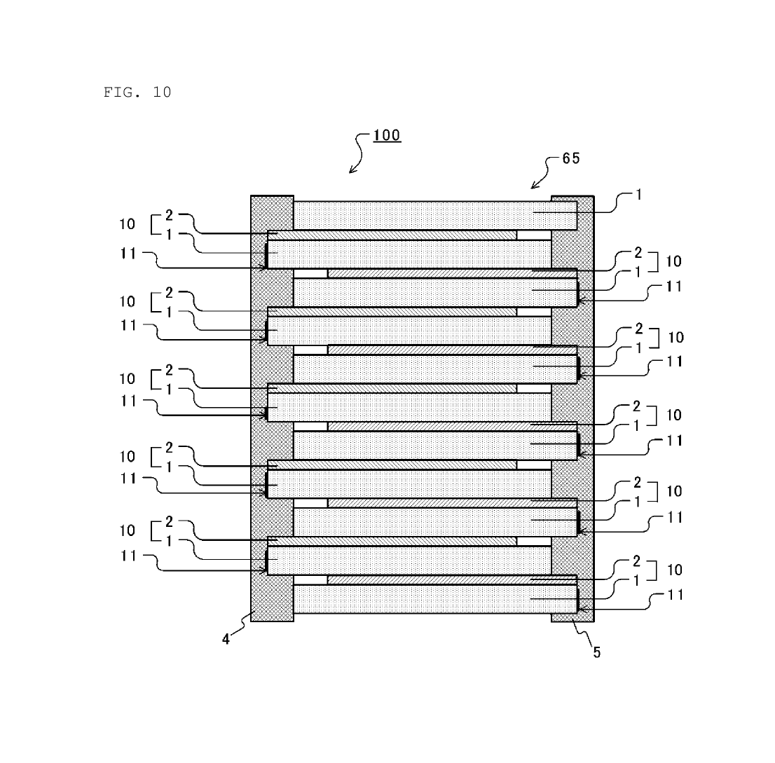

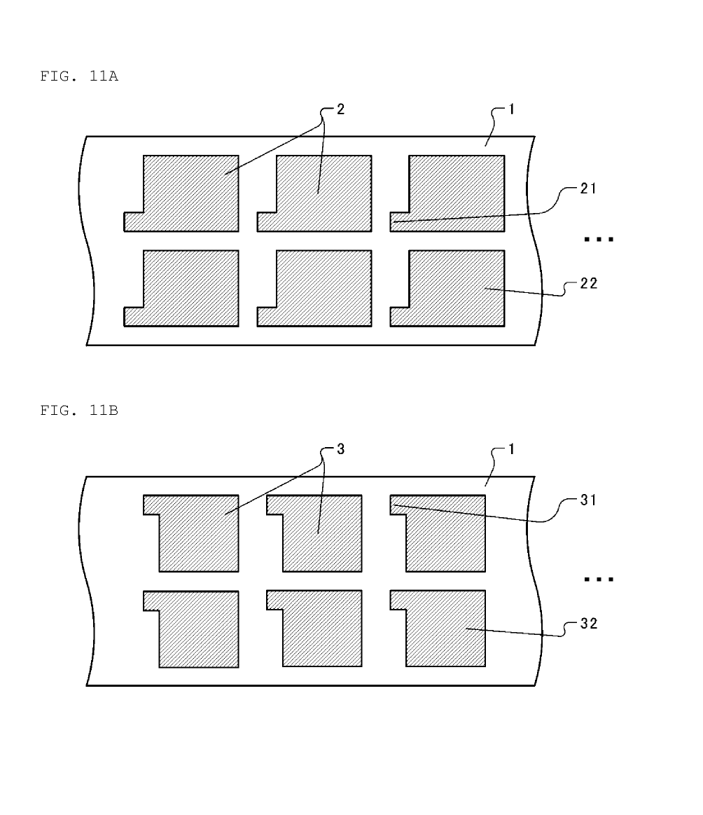

A stacked film capacitor 100 shown in FIG. 10 is manufactured by steps S1 to S6 described above.

As described above, according to the manufacturing method of the stacked film capacitor according to the first embodiment, a plurality of sheets 10 on which a plurality of internal electrode layers 2 are deposited and where a separation line P is formed along one side of each internal electrode layer 2 are formed from one (one type of) film 1, and a stack 60 is formed by alternately shifting and stacking the sheets 10 in such a way that the internal electrode layer 2 is exposed at the separation line P at an end portion of each sheet 10. The internal electrode layer 2 may thereby be efficiently exposed, and the Metallikon sections 4 and 5 formed at end portions of respective sheets 10 and the internal electrode layers 2 may be reliably electrically connected. Also, according to this manufacturing method, there is no need to perform heat treatment at high temperature, special coating, special chemical treatment, and the like. Thus, the manufacturing efficiency of this manufacturing method is high.

Additionally, in the present embodiment, the sheets 10 have a common structure, but the structures of the sheets 10 forming a separated stack 65 may be different from one another. For example, the structure may be different between the internal electrode layer 2 arranged on an even-numbered layer and the internal electrode layer 2 arranged on an odd-numbered layer. Also, the structure of the internal electrode layers 2 on some layers may be different from that of the internal electrode layers 2 on other layers. Furthermore, some or all of the internal electrode layers 2 may be provided with a fuse or the like.

Moreover, instead of rotating the sheets 10 by 180 degrees as shown in FIG. 5, sheets of corresponding arrangement may be formed.

The sheets 10 are arranged with their positions shifted between the odd-numbered layers and the even-numbered layers, but it is also possible to adjust the positions of the internal electrode layers 2 on the sheets 10 so as to have the internal electrode layers 2 of the odd-numbered layers exposed at one end surface of the separated stack 65 and the internal electrode layers 2 of the even-numbered layers exposed at the other end surface of the separated stack 65 in a state where the sheets 10 are uniformly stacked.

### Second Embodiment

A manufacturing method of a stacked film capacitor according to a second embodiment of the present invention will be described with reference to the drawings. In the manufacturing method according to the first embodiment, the present invention has been described citing an example of forming a stacked film capacitor using one type of film sheet, but in the manufacturing method according to the second embodiment, a case of forming the stacked film capacitor using two types of film sheets will be described. Also, in the manufacturing method according to the first embodiment, a case where the Metallikon sections 4 and 5 are formed at respective end surfaces of the separated stack 65 has been described, but in the manufacturing method according to the second embodiment, a case where a Metallikon section 4 is formed at one end surface of the separated stack 65 will be described. Additionally, the manufacturing steps of the stack film capacitor include the same steps as the manufacturing steps shown in FIG. 1 according to the first embodiment.

As shown in FIG. 11A, in the internal electrode layer forming step (step S1), a plurality of internal electrode layers 2 are formed in row and column directions on the surface of a film 1. Also, as shown in FIG. 11B, a plurality of internal electrode layers 3 are formed in row and column directions on the surface of another film 1 different from the film 1 on which the internal electrode layers 2 are formed. The internal electrode layers 2 and 3 are both formed by depositing a metal film on the film 1. The shapes (electrode patterns) and sizes of the internal electrode layers 2 and 3 are different, and the layer of the internal electrode layers 2 and 3 that is to come into contact with the Metallikon section 4 is larger than the layer that is not to come into contact with the Metallikon section 4. For example, in the present embodiment, the internal electrode layer 2 is the layer that is to come into contact with the Metallikon section 4, and the internal electrode layer 2 is formed to be larger than the internal electrode layer 3. The internal electrode layers 2 and 3 are both formed at certain intervals along the long direction (the row direction) of the film 1, for example, and two layers are arranged in the short direction of the film 1.

The internal electrode layer 2 includes an extended area 21 and a main area 22. The extended area 21 is an area having an area protruding from the main area 22 along the long direction of the internal electrode layer 2. That is, the length in the long direction of the internal electrode layer 2 including the extended area 21 is longer than the length in the long direction of the internal electrode layer 2 not including the extended area 21.

The internal electrode layer 3 includes an extended area 31 and a main area 32. The extended area 31 is an area having an area protruding from the main area 32 along the long direction of the internal electrode layer 3. That is, the length in the long direction of the internal electrode layer 3 including the extended area 31 is longer than the length in the long direction of the internal electrode layer 3 not including the extended area 31.

The extended area 21 of the internal electrode layer 2 and the extended area 31 of the internal electrode layer 3 are provided at positions that do not overlap in the stacking direction of a stacked film capacitor 100.

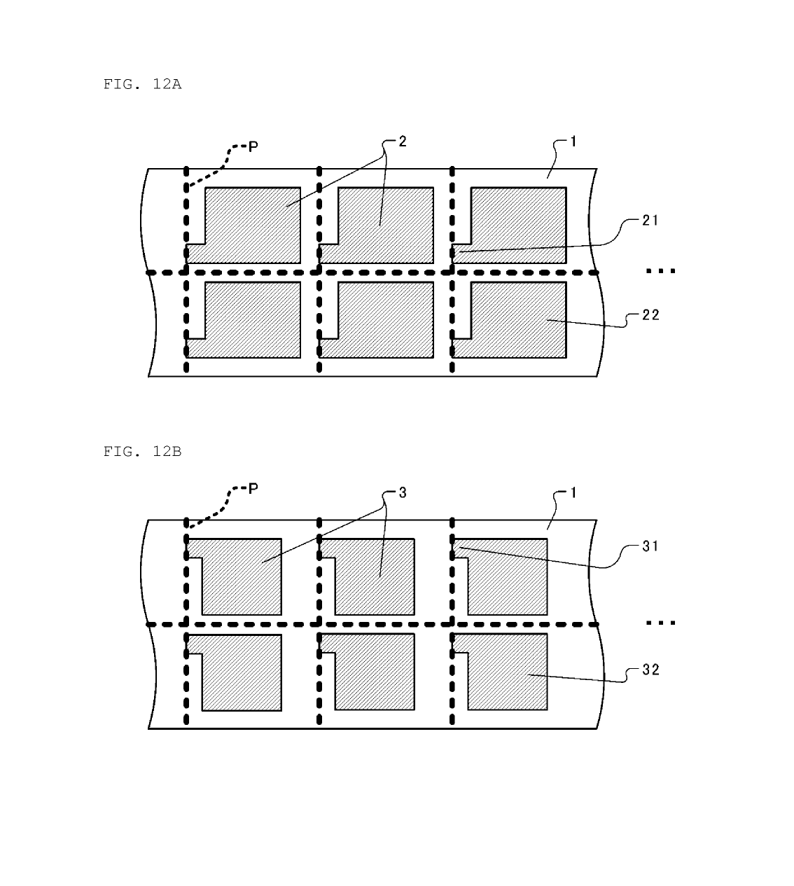

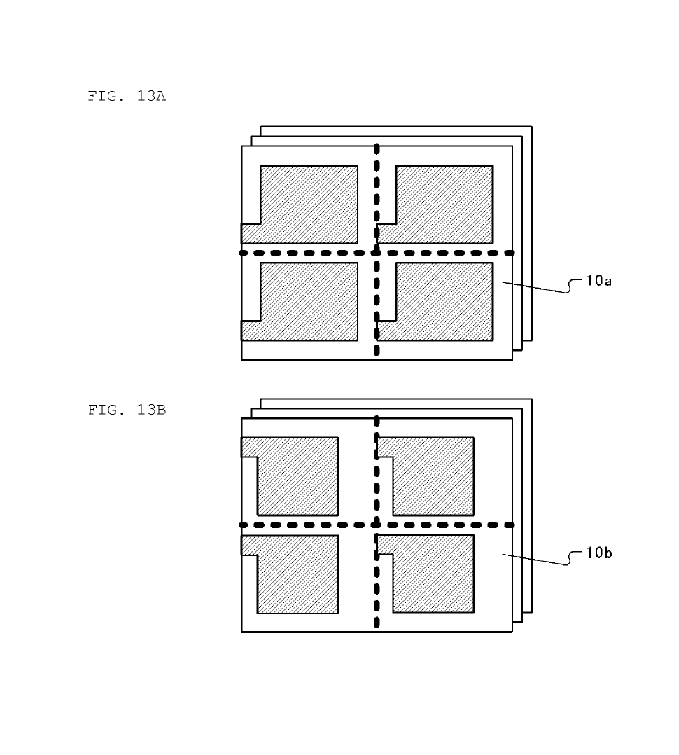

As shown in FIG. 12A, in the separation line forming step (step S2), separation lines P are formed along the short and long directions of the film 1 on which a plurality of internal electrode layers 2 are formed. Also, as shown in FIG. 12B, separation lines P are formed along the short and long directions of the film 1 on which a plurality of internal electrode layers 3 are formed. The separation lines P along the short direction of the films 1 are formed along respective one sides, along the short direction, of the extended areas 21 and 31 of the internal electrode layers 2 and 3, and the separation lines P along the long direction of the films 1 are formed in the middle of the short direction (between the internal electrode layers 2 or 3) of the films.

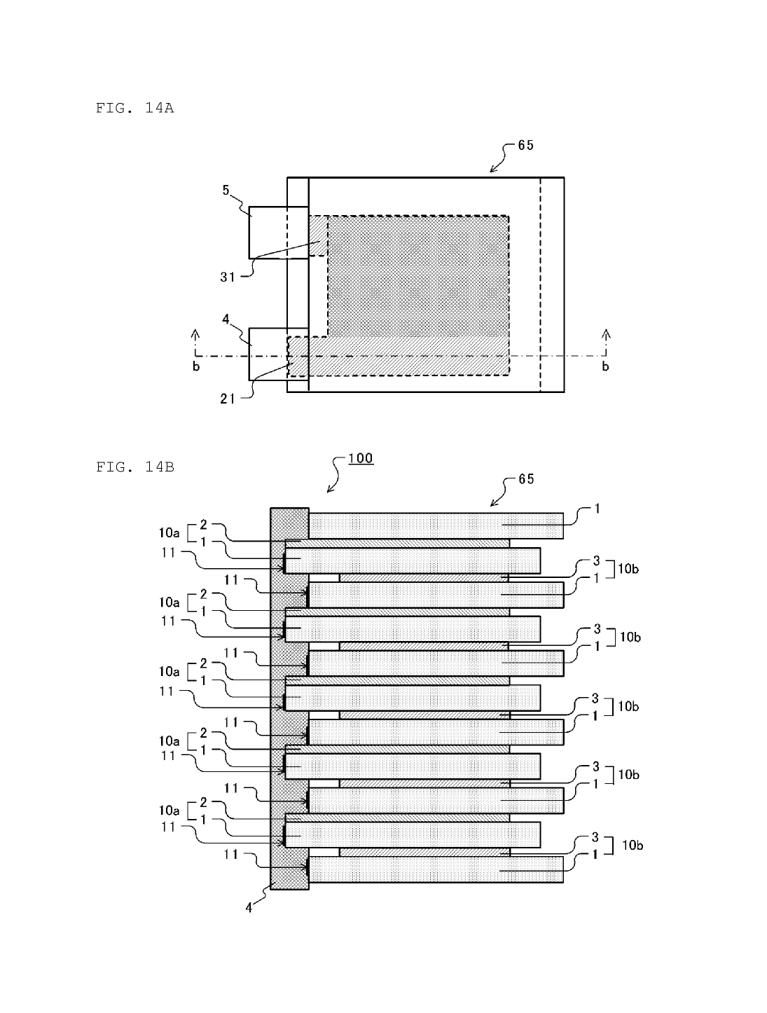

In the sheet making step (step S3), every second separation line P formed along the short direction of the film 1 is cut (for example, even-numbered or odd-numbered separation lines P are cut). One film 1 is thereby divided into a plurality of sheets 10a and 10b, as shown in FIGS. 13A and 13B. Moreover, each of the sheets 10a and 10b includes four internal electrode layers 2 or internal electrode layers 3.

In the stacking step (step S4), each sheet 10a and each sheet 10b are positioned and stacked with the positions of the sheets shifted from each other in such a way that the internal electrode layer 2 is partially exposed at the separation line P at an end portion of each sheet 10a. Also, a film 1 having the same size as the films 1 of the sheets 10a and 10b is stacked at the uppermost layer. A stack 60 is thereby formed.

(Separation Step)

In the separation step (step S5), the stack 60 is pulled from both sides of the short direction, so that each of the sheets 10a and 10b is separated into two. Also, by pulling the separated stack 60 from both sides of the long direction, each of the sheets 10a and 10b are further separated into two, and falls into a state where one internal electrode layer 2 or one internal electrode layer 3 is included. Additionally, to maintain the stacked state of the sheets 10, the stack 60 may be pulled while being pressed in the stacking direction.

In the Metallikon section forming step (step S6), as preprocessing, surface treatment is applied on an end surface of the sheet 10b at an area where the Metallikon section 5 is to be formed. Contact between the Metallikon section 5 formed in the Metallikon section forming step and the internal electrode layer 3 of the sheet 10b is thereby improved. Then, as shown in FIGS. 14A and 14B, the Metallikon sections 4 and 5 are formed by thermally spraying a thermal spray material (a metallic material such as nickel, aluminum, etc.) on the surface (an end surface) on the side where the internal electrode layer 2 of the sheet 10a of the separated stack 65 is partially exposed. The part where the extended area 21 is exposed is to be in contact with the Metallikon section 4. The main area 22 of the internal electrode layer 2 and the Metallikon section 4 are thereby made to be in contact with each other, and electrical connection is secured. Furthermore, the extended area 21 is configured as a positive electrode, and the extended area 31 is configured as a negative electrode.

As described above, according to the manufacturing method of a stacked film capacitor according to the second embodiment, a stacked film capacitor 100 may be manufactured using two types of film sheets. Also, the Metallikon section 4 formed at an end surface of the separated stack 65 and the internal electrode layer 2 may be reliably electrically connected.

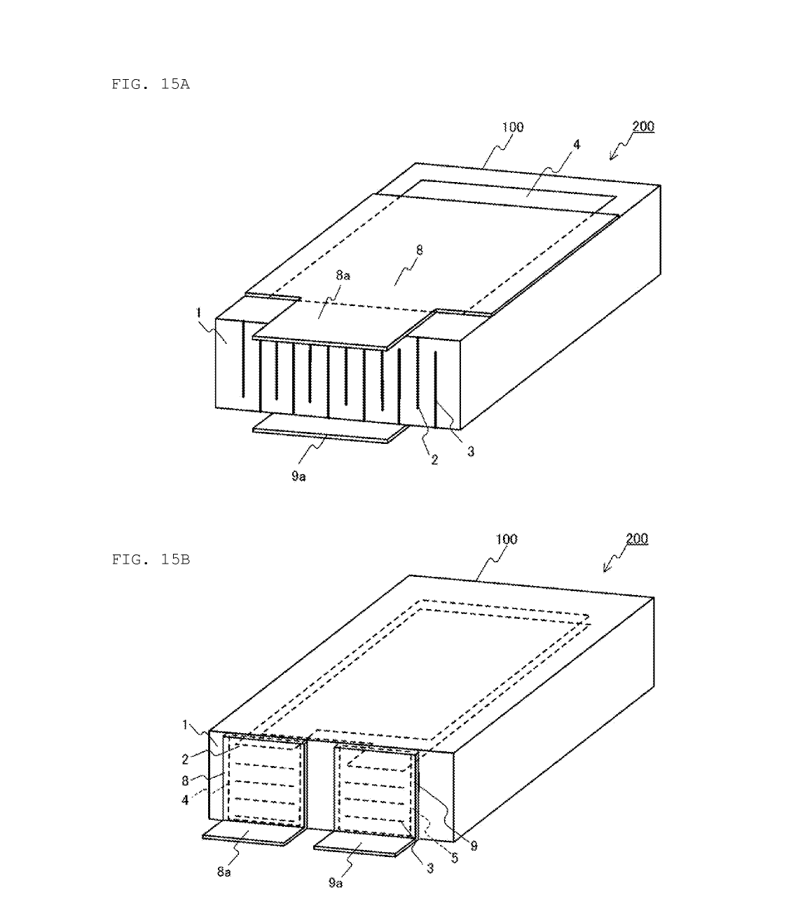

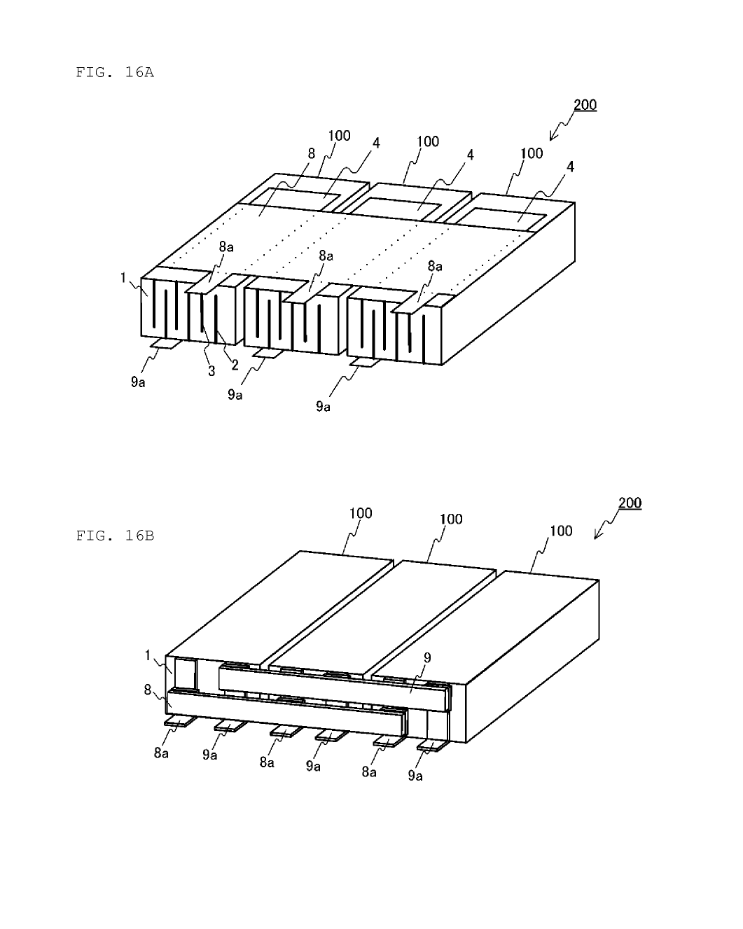

The stacked film capacitor 100 manufactured by the manufacturing method of one of the first and second embodiments described above may be provided to a capacitor module 200. For example, as shown in FIGS. 15A and 15B, the capacitor module 200 is configured from the stacked film capacitor 100, and external electrodes 8 and 9. The external electrodes 8 and 9 are provided with external electrode terminals 8a and 9a for connecting to an external electronic component. Additionally, the capacitor module 200 is molded from resin. Also, as shown in FIGS. 16A and 16B, a plurality of stacked film capacitors 100 may be provided to one capacitor module 200.

Furthermore, the stacked film capacitor 100 manufactured by the manufacturing method of one of the first and second embodiments described above may be used in a power conversion system for converting between a DC power signal and an AC power signal as a smoothing capacitor for reducing the ripple of the power signal. For example, the stacked film capacitor 100 may be adopted by a power conversion system that is used with the input side and the output side connected to a battery and a motor, respectively.

In the embodiments described above, an example where two internal electrode layers 2 are formed in the internal electrode layer forming step along the short direction of the film 1 has been described, but more than two internal electrode layers 2 may alternatively be formed, and the number thereof is not restricted. Also, in the same manner, the number of the internal electrode layers 2 and 3 to be provided to the sheets 10 made in the sheet making step is not restricted. Furthermore, the internal electrode layers 2 and 3 provided to the sheets 10 are arranged in rows and columns, but the arrangement of the internal electrode layers 2 and 3 is not restricted to such an arrangement.

In the embodiments described above, every second separation line P is cut in the sheet making step, but this is only exemplary. For example, every third separation line may alternatively be cut according to the number of the internal electrode layers 2 and 3 provided to each of the sheets.

Also, the separation line P does not have to be formed at a position to be cut in the sheet making step S3.

In the embodiments described above, the sheet 10 is made in the sheet making step S3 after the separation line forming step S2, but the present invention is not limited to be such. For example, the rectangular film 1 described in the embodiments above may be used as it is, thereby abbreviating the sheet making step. Moreover, the rectangular film 1 may be cut, before the separation line forming step of the embodiments above, to the size of a film to be used in the stacking to thereby make the sheet 10.

In the embodiments described above, the sheets are simply stacked in the stacking step, but one of pressing treatment and heat treatment may also be applied to the stacked sheets in the stacking step. Also, heat treatment may be applied in addition to pressing treatment.

Furthermore, components other than the sheets may also be stacked.

In the embodiments described above, an example is described where the separation lines P are formed adjacent to the internal electrode layers 2 for connection with the Metallikon sections 4 and 5, but the position of the separation line P is arbitrary so long as the sheet 10 may be separated into pieces including the internal electrode layers 2. Cutting performed to arrange a part of the internal electrode layer 2 at an end surface of the separated stack 65 may alternatively be performed only in a cutting step.

Also, the separation line P does not have to be formed at the position to be cut in the cutting step.

Moreover, the present invention is not to be limited by the description of the embodiments above and the drawings, and the embodiments and the drawings may be changed as appropriate.

What is claimed is:

1. A method of manufacturing a stacked film capacitor, the method comprising:
forming a plurality of first internal electrodes on a first dielectric film, and forming a plurality of second internal electrodes on a second dielectric film;
forming a first separation line at a position between the plurality of first internal electrodes on the first dielectric film, and forming a second separation line at a position between the plurality of second internal electrodes on the second dielectric film;
stacking the first dielectric film and the second dielectric film such that the first separation line and the second separation line are arranged at positions different from each other when seen along a stacking direction so as to form a stack;
separating the stack at the first separation line and the second separation line into a plurality of separated stacks; and
forming a first external electrode connected to the first internal electrode and a second external electrode connected to the second internal electrode.

2. The method of manufacturing a stacked film capacitor according to claim 1, wherein the stack is separated by applying forces in opposite directions to each other on opposed sides of the first separation line and the second separation line, respectively.

3. The method of manufacturing a stacked film capacitor according to claim 1, wherein the first external electrode and the second external electrode are formed by Metallikon treatment.

4. The method of manufacturing a stacked film capacitor according to claim 1, wherein the first separation line is formed at a position adjacent to the first internal electrode on the first dielectric film, and the second separation line is formed at a position adjacent to the second internal electrode on the second dielectric film.

5. The method of manufacturing a stacked film capacitor according to claim 4, wherein the first dielectric film and the second dielectric film are stacked such that the first internal electrode is exposed at a first end surface of the separated stack, and the second internal electrode is exposed at a second end surface of the separated stack.

6. The method of manufacturing a stacked film capacitor according to claim 5, wherein the first external electrode is formed on the first end surface of the separated stack and the second external electrode is formed on the second end surface of the separated stack.

7. The method of manufacturing a stacked film capacitor according to claim 1, wherein the first internal electrode including a first extended area and a first main area is formed on the first dielectric film, and the second internal electrode including a second extended area and a second main area is formed on the second dielectric film.

8. The method of manufacturing a stacked film capacitor according to claim 7, wherein the first separation line is formed at a position adjacent to the first extended area of the first internal electrode on the first dielectric film, and the second separation line is formed at a position adjacent to the second extended area of the second internal electrode on the second dielectric film.

9. The method of manufacturing a stacked film capacitor according to claim 8, wherein the first dielectric film and the second dielectric film are stacked such that the first extended area of the first internal electrode is exposed at a first position of a first end surface of the separated stack, and the second extended area of the second internal electrode is exposed at a second position of the first end surface of the separated stack, the first position being different from the second position.

10. The method of manufacturing a stacked film capacitor according to claim 9, wherein the first external electrode is connected to the first extended area of the first internal electrode and the second external electrode is connected to the second extended area of the second internal electrode on the first end surface of the separated stack.

11. The method of manufacturing a stacked film capacitor according to claim 1, further comprising:
forming a third separation line that is orthogonal to the first separation line on the first dielectric film, and forming a fourth separation line that is orthogonal to the second separation line on the second dielectric film; and
stacking the first dielectric film where the third separation line is formed and the second dielectric film where the fourth separation line is formed such that the third separation line and the fourth separation line are arranged at an overlapping position when seen along the stacking direction.

12. A stacked film capacitor manufactured by the method according to claim 1.

13. A stacked film capacitor comprising:
a stacked body having a first internal electrode, a first dielectric film, a second internal electrode, and a second dielectric film stacked in this order such that the first internal electrode and the second internal electrode face each other across the first dielectric film; and
a first external electrode connected to the first internal electrode and a second external electrode connected to the second internal electrode,
wherein the first dielectric film and the second dielectric film include broken portions at peripheral portions thereof.

14. The stacked film capacitor according to claim 13, wherein the first internal electrode includes a first extended area and a first main area, and the second internal electrode includes a second extended area and a second main area.

15. The stacked film capacitor according to claim 14, wherein the first extended area of the first internal electrode is exposed at a first position of a first end surface of the separated stack, and the second extended area of the second internal electrode is exposed at a second position of the first end surface of the separated stack, the first position being different from the second position.

16. The stacked film capacitor according to claim 15, wherein the first external electrode is connected to the first extended area of the first internal electrode and the second external electrode is connected to the second extended area of the second internal electrode.
